(19) United States
(12) Patent Application Publication
(10) Pub. No.: US 2024/0028715 A1
(43) Pub. Date: Jan. 25, 2024

(54) CENTRAL CYBER COORDINATOR

(71) Applicant: CYBER INDEMNITY SOLUTIONS LIMITED, Birkenhead (NZ)

(72) Inventors: Mickael Hyatt, North Isis (AU); Gregory Hugh Hodgkiss, Doreen (AU)

(21) Appl. No.: 17/869,263

(22) Filed: Jul. 20, 2022

(51) Int. Cl. G06F 21/56; G06F 8/61; G06F 8/65

(52) U.S. Cl. CPC G06F 21/56; G06F 8/61; G06F 8/65; G06F 2221/031; G06Q 10/0635

(57) ABSTRACT

A dynamic cyber insurance policy, in one example, may change its premiums, exclusions, and conditions given a score derived from a suite of inputs across a monitored and measured environment. Both real-time and historical data gathered from several environments may be used to calculate a risk-based score. This score may be used to determine what premiums, exclusions, and conditions a policy will have. This may be performed monthly or at other intervals. It may provide an efficient way for insurers to measure and apply risk directly to policies, rewarding and incentivizing insureds to continually manage cyber risks.

### TECHNICAL FIELD

This disclosure relates to computer systems.

### BACKGROUND

A company's data, in certain situations, can be one of its most valuable assets. Properly managing such data can include taking appropriate measures to ensure its security and arranging to be compensated in the event of its loss.

### SUMMARY

A cyber coordination system includes one or more processors that, responsive to input requesting a first type of cyber audit of remote computers, communicate with the remote computers to determine whether each of the remote computers has ransomware protection enabled, and responsive to data indicating that at least one of the remote computers has ransomware protection disabled, generate a report indicating that the at least one of the remote computers has ransomware protection disabled. The one or more processors also, responsive to input requesting a second type of cyber audit of the remote computers, communicate with the remote computers to determine whether each of the remote computers has ransomware protection enabled, and responsive to data indicating that at least one of the remote computers has ransomware protection disabled, generate a command for the at least one of the remote computers to update settings to enable ransomware protection such that the at least one of the remote computers enables ransomware protection.

A cyber coordination system includes one or more processors that, responsive to input requesting a first type of cyber audit of remote computers, communicate with the remote computers to determine whether each of the remote computers has a specified patch for software, and responsive to data indicating that at least one of the remote computers does not have the specified patch, generate a report indicating that the at least one of the remote computers does not have the specified patch. The one or more processors also, responsive to input requesting a second type of cyber audit of the remote computers, communicate with the remote computers to determine whether each of the remote computers has the specified patch for software, and responsive to data indicating that at least one of the remote computers does not have the specified patch, generate a command for the at least one of the remote computers to install the specified patch such that the at least one of the remote computers installs the specified patch.

A cyber coordination method includes, responsive to a score, derived from data that results from monitoring a plurality of endpoints, being within a desired range of values and the data indicating that one of the endpoints has ransomware protection disabled or does not have a specified patch for software, generating an alert. The method also includes, responsive to the score being outside the desired range of values, commanding the one of the endpoints to enable ransomware protection such that the one of the endpoints enables ransomware protection or to install the specified patch such that the one of the endpoints installs the specified patch.

### BRIEF DESCRIPTION OF THE DRAWINGS

FIGS. 1 and 2 are schematic diagrams of cyber coordinators and client systems.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The availability and cost of insuring data may depend on factors such as the hardware on which it is stored, the geographic location of such hardware, and the policies and procedures used in handling it. These policies and procedures may include cybersecurity policies and procedures. That is, the availability and cost of insuring data may depend on the measures taken to defend against cyber-attacks.

A cybersecurity audit platform is contemplated that helps and supports organizations, large and small, with their compliance, cybersecurity requirements, and legal obligations. It facilitates a thorough “business” cyber audit—not just an information technology audit. The cyber risk assessment may evaluate the organization's cyber risks across their business practices, creating a cyber risk profile of business operations including detailed information technology controls and requirements.

The platform may also provide a workflow that allows a manager to assign recommendations to address and implement risks and functionality to manage the progress and completion of those recommendations. These update the metrics in the platform and can demonstrate continuous improvement. The platform may also incorporate artificial intelligence with several data feeds to provide a fully comprehensive cyber risk and capability dashboard that allows a company to clearly see where rising threats, vulnerabilities, and incidences are occurring within key areas that impact security (e.g., business, technology, people and process, and insurance). These areas can be broken down further into numerous dimensions that include but are not limited to internal and external security, workforce roles, employee habits, third parties, insurance analysis, governance, privacy, and regulatory compliance.

The dashboard may be customizable, ensuring that the data is meaningful; it may also extend to provide countermeasures to improve security levels and, through education/training feeds, raise the cyber skills of the entire workforce.

The data may be valuable for the insurance industry from a pricing perspective and can provide an audit trail of a cyber incident and performance should a breach, permanent data loss, cyber extortion, or other insurance event occur, and support reporting responsibilities to any relevant regulatory bodies.

Through a holistic cyber audit, companies can confidentially determine where improvements are required to strengthen cyber defenses. The platform may include broad based audits, recommendations, risk management, workflows, regulatory reporting, and evidence-based management systems, autoconfiguration of external systems, with steps to follow and templates, and example policies and procedures to support a poorly resourced sector. The platform may be highly configurable to develop audit-based systems to measure and determine compliance with a fast changing regulatory and standards environment.

Businesses must address a very complex, changeable, cyber risk environment. Having low expertise to self-manage and high costs to outsource, the risks and threats to the business are either poorly addressed or at worst, ignored. In an environment where cyber insurance is a key cyber risk mitigation strategy, insurers may be reluctant to offer appropriate cyber insurance or outright refuse to insure because of the complex risk environment and the inability to measure the risks to determine appropriate policy wording, price, terms, and/or conditions. The platform seeks to address these challenges and issues from the business and the insurer points of view.

How does one define the risk environment for their business? What does a particular risk environment look like? How does it operate within the cyber threat context? Answers to these questions can guide a cyber risk strategy and ultimately a cyber profile.

Gap Analysis/Cyber Exposure: There will be base threats that affect all systems including unauthorized access (malicious or accidental), loss of data, disruption of services, data leaks, misuse and/or exposure, insider threats, and third-party risks.

Compliance: Almost every regulatory compliance requirement has a comprehensive risk audit. Traditionally, these audits measure compliance at a point in time and do not have any dynamic or real-time components to monitor on-going compliance. The platform may evaluate compliance controls and help businesses understand their full range of risk exposure. Additionally, the technology, algorithms, and design of the platform may dynamically provide real-time compliance measures through its scoring system and either alert when an element of the environment is not compliant and/or change configurations to rectify an element that is no longer compliant as discussed more below. The platform may also help prioritize risks, map risks to the applicable risk owners, and effectively allocate resources to risk activities. The platform may thus identify and locate vulnerabilities in information technology and business processes and address those threats in meaningful ways. The key challenges addressed include knowledge of the current environment, what mitigation activities are most important, proactive cyber defense, using multiple layers of cyber defense (defense-in-depth), and implementing a full business management structure for cyber and data risk management.

A company's cyber resilience capability is only as good as their ability to prepare for and adapt to continuously changing conditions, with the agility to withstand and quickly recover from cyber disruption. There may, however, be a few challenges. First, companies have numerous providers of cyber solutions; these providers usually do not collaborate, making it difficult to obtain a holistic view of cyber strengths and vulnerabilities, and more importantly making management of risks more difficult. The platform may connect the data feeds of multiple cyber products and services into one place and deliver the information and reporting from these feeds into easily digestible and focused compliance scores given the audit requirements of the business/entity.

Second, resilience requires a focus on prevention, detection, and reactive measures by continuously assessing and monitoring gaps or weaknesses within multiple areas across the business and not just technology, as cyber resilience is far broader than sharpening one's information technology defenses. The platform through its monitoring and assessment feeds may detect when a system falls outside the cyber resilience and/or compliance parameters and either send configuration changes to rectify the fault and/or notify the relevant parties to address the lapse in compliance.

Third, companies are still over emphasizing information technology's role in protecting a company from a cyber-attack, and need to extend beyond information technology and include people, process, compliance, governance, cyber risk management, education/employee training, insurance, third parties, connectivity, etc. to help everyone play a role in the cybersecurity of a company. The platform and its technologies and processes bring these several roles and responsibilities into a single place to manage the cyber environment more efficiently.

What is audited, assessed, and monitored may include but not be limited to, within the context of business, cyber risk strategy, management framework, cyber audit, data breach, business continuity and recovery, incident response, procurement, third parties, governance, and legal and compliance. Within the context of technology, it may include account management, configuration management, authentication, rights management, threat monitoring, vulnerability testing, penetration testing, physical security, and portable and/or mobile devices. Within the context of people and process, what is measured depends on data that a company has available and what can legally be identified based on the companies' employment contract. Data sets can relate to risk of accidental insider threats, risk of malicious insider threats, risk of compromised insider threat accounts, user behavior analytics, anomaly detection, sentiment analysis, email activity, web activity, social media activity, voice and video evaluation, cyber training and education levels, cyber awareness, compliance testing, encryption of files and access levels, and biometrics. Within the context of insurance, all business policies may be assessed and audited including but not limited to property, cyber, data, general liability, automotive, workers compensation, insurance gaps, first party, and third party.

The cyber risk assessment may provide an organization with a cyber risk profile that is not just a one-time measurement but pulsed and updated based on ongoing improvements the organization is completing. This holistic, multi-dimensional cyber risk solution is all about building the machinery of the organization to develop and maintain cyber resilience.

Post-assessment and using the platform, organizations may manage risks and monitor how changes in their organization (e.g., people, technology, acquisitions/divestitures, new markets, insurance, legislation, etc.) impact their ability to protect their data and organization from cyber threats, providing a holistic real-time cost-effective cyber solution.

Organizations can thus proactively manage cyber risk and monitor it through a customized dashboard, giving them a holistic view of their cyber posture. Using the platform, organizations may be protected by several layers that also support the event of a cyber breach. Building high cyber resilience reduces cyber impact.

The platform may assist in ensuring technology is fit for purpose and is being used with other layers of protection to leverage a more cost-effective way to use technology as a fabric of cyber defense and response. It may also identify conflicting solutions that may weaken a company's cyber posture as well as highlighting cyber providers and any duplication of services that may undermine the cyber posture as well as condense providers and provide purchasing power.

The platform may also ensure everyone in the business is part of the solution and not the problem. It may connect various data sets and, when linked, flag the rising risk of a malicious, accidental, or compromised insider threat, in order to stop such attacks before they occur. It may also flag subtle changes in behavior to provide the right level of support to the workforce that results in a cyber educated and content workforce.

The right insurance policies for business can help to minimize business interruption and protect officeholders from personal liability. Ensuring the organization and officers have the right level of coverage and exposure, and a sure knowledge of what the business needs, the platform may provide a clear understanding of what is not included. Understanding cyber exposures are key for both policyholders and insurers by ensuring policyholders get the payouts they need and helping insurers to minimize loss ratios on non-cyber policies. Ensuring policy compliance by static and dynamic auditing of the requirements allows transparency for the insurer and the insured.

Antivirus software (e.g., ransomware, security patches) and firewalls are typically used as part of a comprehensive cyber protection program. Here, we further describe systems (e.g., a cyber coordinator) that monitor and implement such cyber-protective measures, and evaluate a strength of the same. This assessment of strength can then be used by data insurance provides when determining whether and to what extent data insurance may be made available and at what cost.

In one scenario, a user indicates to the cyber coordinator the number and type of endpoints being used (e.g., twenty-five computers running Linux), and installs an endpoint detection and response agent and/or a patch manager on each of the endpoints. An application programming interface of the cyber coordinator then communicates with the endpoints via the endpoint detection and response agents. Given this arrangement, the cyber coordinator may monitor the endpoints, for example, to determine whether certain machines are active, whether ransomware protection is enabled, whether various software and corresponding patches are current, etc. The cyber coordinator may then further command the endpoints, for example, to enable ransomware protection and/or update software patches as will be discussed in more detail.

The activities described above can be performed as part of an evaluation of the cyber health of an entity by the cyber coordinator. Continuing with the scenario above, the user specifies a type of cyber audit they desire the cyber coordinator to perform. The type, in this example, dictates the quality of the cyber protection program (as defined by the associated criteria for compliance) the user desires to have in place. More stringent types require more and higher quality levels of protection, whereas less stringent types do not. Based on the type identified, the cyber coordinator evaluates a variety of information, including the monitored information mentioned above, to determine whether and to what extent the cyber controls currently enacted by the user for its machines and systems meet the requirements (criteria) defined by the type. The cyber coordinator may thus generate a score indicating the degree to which the cyber controls satisfy the selected standard: the more criteria satisfied, the better the score. This score can be used by third-party providers of insurance when determining availability, premiums, etc. The score can also be used by the cyber coordinator in determining whether to take corrective actions. If the score falls within some desired range, no corrective actions may be taken and/or alerts may be generated. If the score falls outside the desired range, commands may be generated to enable ransomware protection, install software patches, etc. if such is not already present.

In certain circumstances, the cyber coordinator may automatically command the endpoints to change or update various cyber settings to satisfy requirements and/or improve their cyber score. If for example an audit type requires that all endpoints have ransomware protection enabled, and information from some of the endpoint detection and response agents indicates that such is not active on some machines, the cyber coordinator may generate commands for the endpoint detection and response agents that is communicated via the application programming interface instructing them to enable ransomware protection on the machines for which it is not currently active. The cyber coordinator may similarly generate commands for the patch managers to update software patches responsive to indication that software patches are out of date. In other circumstances, the cyber coordinator may prompt the user to give it permission to generate the commands previously discussed before issuing them.

With completion of the audit, including any updates to ransomware protection, software patches, etc., the cyber coordinator may recommend further changes (e.g., changes that cannot be automatically made by the cyber coordinator) to improve the audit score and track compliance with audit type. It, for example, may recommend relevant cyber training, revisions to data back-up procedures, etc., and provide a central repository for the user to store and track evidence that the user has implemented or completed the recommendations.

A scenario that describes a specific feature that can be utilized by the methods, algorithms, and processes is dynamic cyber insurance. A dynamic cyber insurance policy changes its premiums, exclusions, and conditions given a score derived from a suite of inputs across the monitored and measured environment. Both real-time and historical data gathered from several environments are used to calculate a risk-based score. This score is used to determine what premiums, exclusions, and conditions a policy will have. This may be performed monthly or at other intervals. It provides an efficient way for insurers to measure and apply risk directly to policies, rewarding and incentivizing insureds to continually manage cyber risks.

A platform software as a service, cyber risk management system may thus access several data feeds, gather third party data to present in the platform, link a client identifier in one or more electronic datasets with the platform that will contribute to compliance levels of the client, create a data store for compliance related documents, prompt/notify a user to activities of non-compliance with tools that will rectify the compliance issue, receive input from application programming interfaces that will be used to determine insurance-based premiums, receive input from application programming interfaces that will be used to determine insurance-based inclusions and exclusions, and store a list of changeable conditions that determine levels of compliance given a specific audit area. At least one device may address a non-compliance issue that has been detected. A selected audit and compliance level may define an insurance premium. A selected audit may define a set of compliance measurements and controls. A selected audit may determine the data management system. The data management system may include categorized file systems to store all electronic evidence of compliance and cyber risk activities.

A method for managing compliance may include prompting a user to choose which type of audit is required, receiving input to determine the level of compliance that is desired/required, and linking an identifier (client) with multiple third-party platforms to monitor and continually measure compliance across cyber education, endpoint detection and response, domain security, email authentication, insurance policies, etc.

In another example, a cyber coordinator may monitor a plurality of endpoints (e.g., computers, etc.) When a particular one (or more) of the endpoints does not satisfy criteria, which may be defined by government regulations and/or conditions of an insurance policy, the cyber coordinator may automatically generate an alert for a user to indicate non-compliance and/or take action to remedy the non-compliance. If for example, one of the endpoints does not have endpoint protection (e.g., ransomware protection) enabled, the cyber coordinator may automatically generate a command for the one of the endpoints to enable or install endpoint protection.

The cyber coordinator may further compute or determine a score indicating the extent to which the endpoints and associated system comply with the criteria. If the monitoring of the endpoints reveals they comply with all the criteria, the score may achieve its best value. If the monitoring reveals they do not comply with any of the criteria, the score may achieve it worst value. If the monitoring reveals they comply with some of the criteria, the score may achieve a value somewhere between its best and worst values, etc. The cyber coordinator may communicate this score and other information via alert or message to the user and/or take corrective action, such as adjusting the premium of an associated cyber insurance policy as a function of the score: the better the score, the lower the premium. Alternatively, the cyber coordinator may only take corrective action if the score falls outside some desired range of values, or does not meet threshold values. Different levels of corrective action are contemplated. The cyber coordinator may, for example, generate a warning of a single deficiency, automatically correct a single deficiency, generate a warning of an overall deficiency, increase or decrease a premium on an associated cyber insurance policy, or take final action (e.g., cancel an associated cyber insurance policy). Moreover, data collected by the cyber coordinator can be applied by artificial intelligence to develop algorithms that allow the coordinator to take different levels of action.

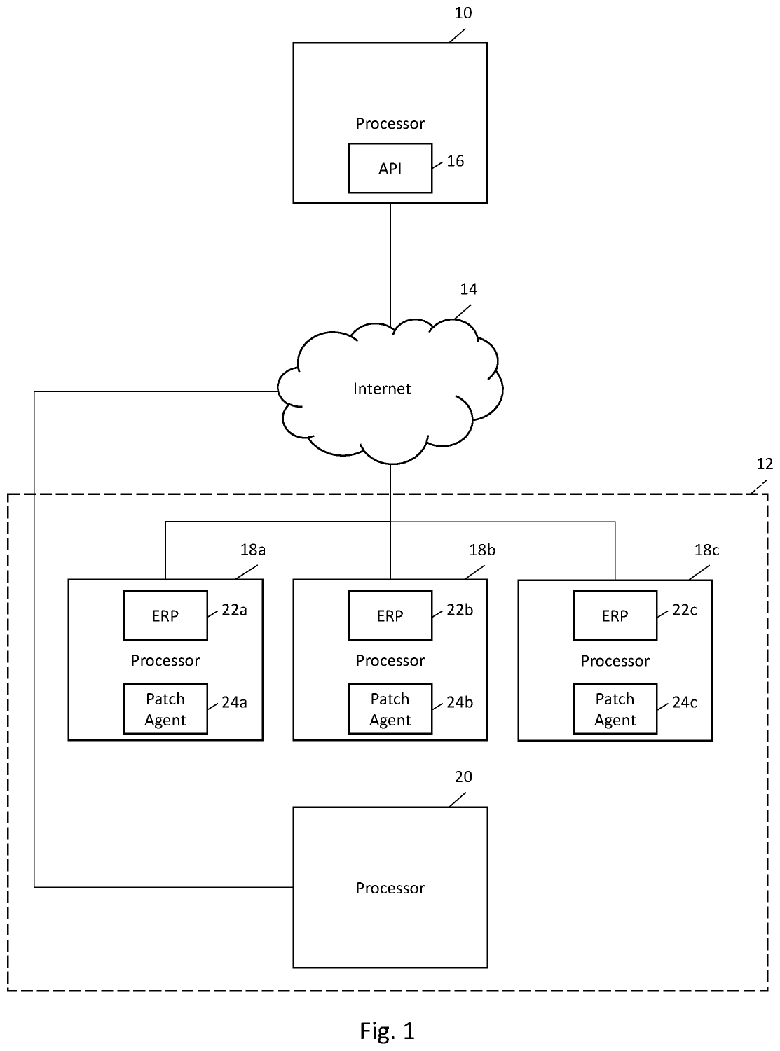

Referring to FIG. 1, an example cyber coordinator 10 (e.g., one or more processors) is in communication with a client system 12 via a network 14 (e.g., Internet). The cyber coordinator 10 includes an application programming interface 16. The client system 12 includes computers 18a, 18b, 18c and computer 20. The computers 18a, 18b, 18c have corresponding endpoint detection and response agents 22a, 22b, 22c, and patch agents 24a, 24b, 24c installed thereon.

The cyber coordinator 10 monitors the computers 18a, 18b, 18c via the application programming interface 16 and interaction with the endpoint detection and response agents 22a, 22b, 22c and patch agents 24a, 24b, 24c. As such, the cyber coordinator 10 can determine whether, for example, the computer 18b has ransomware protection enabled or whether it has current patches installed for its software. To the extent it does not, the cyber coordinator 10 may generate commands, for the endpoint detection and response agent 22b and patch agent 24b and communicate them to the same via the application programming interface 16, that cause the endpoint detection and response agent 22b to enable ransomware protection functionality and the patch agent 24b to update patch software.

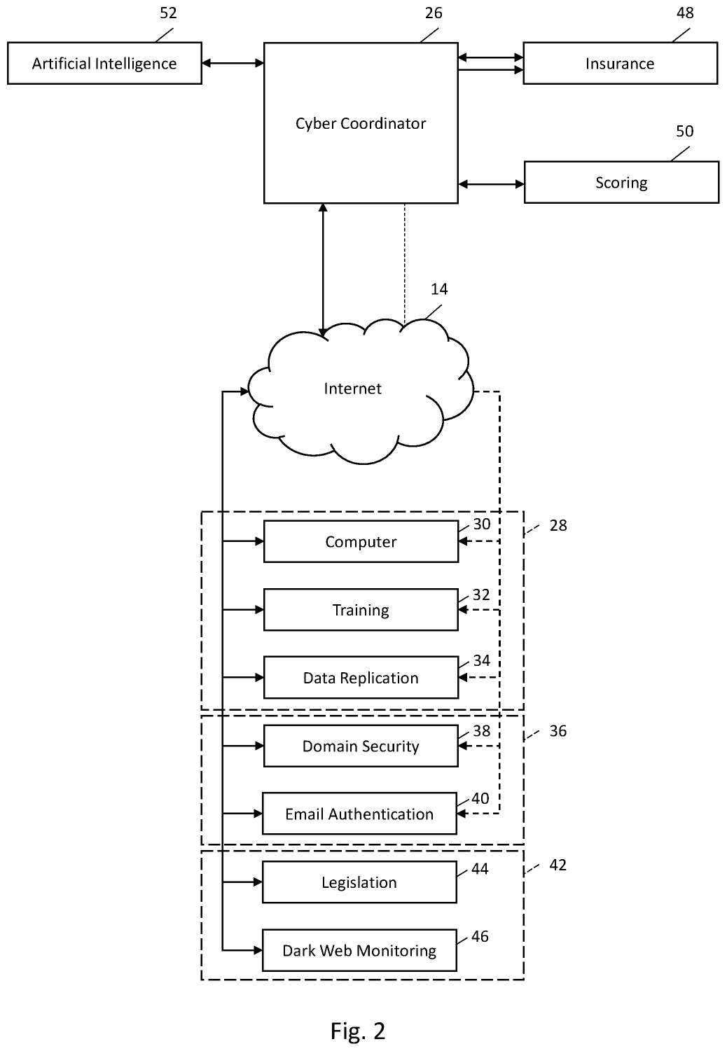

Referring to FIG. 2, an example cyber coordinator 26 (e.g., one or more processors) monitors a number of inputs, which may include internal inputs 28 from a company such as computer 30, which has endpoint detection response, patch agents, and port monitoring, training and education monitoring 32, and data replication monitoring 34, supplier inputs 36 such as domain security monitoring 38 and email authentication monitoring 40, and external inputs 42 such as cyber legislation monitoring 44 and dark web monitoring 46. The cyber coordinator 26 can also receive inputs from the company insurance department 48 for policies, including dynamic policies, regarding policy terms, conditions, exclusions, warranties and other information. The cyber coordinator 26 can then monitor these for compliance.

The cyber coordinator 26 may generate ‘Level 1’ commands to rectify an unsatisfactory monitored input such as reinstalling endpoint protection, issuing a warning to a company that they are not compliant with training, updating email authentication, issuing a warning to the company that the dark web has information on the company, or issuing a warning to the company that they are not compliant with legislation.

The cyber coordinator 26 may have an overall scoring system 50 that tracks compliance with all the monitored inputs and if the score falls below a pre-determined score, the cyber coordinator 26 may generate a ‘Level 2’ command that the company is below the pre-determined score.

If the score stays below a pre-determined score for a certain amount of time, the cyber coordinator 26 may generate a ‘Level 3’ command to one or more of the dynamic policies mentioned above to change price, terms, conditions or other language insuring the company.

The data from the cyber coordinator 26 may be input into artificial intelligence processor 52 to refine the commands from the cyber coordinator 26.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers, and computer and computers, etc.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A cyber coordination system comprising:
one or more processors programmed to,
responsive to input requesting a first type of cyber audit of remote computers, communicate with the remote computers to determine whether each of the remote computers has ransomware protection enabled, and responsive to data indicating that at least one of the remote computers has ransomware protection disabled, generate a report indicating that the at least one of the remote computers has ransomware protection disabled, and
responsive to input requesting a second type of cyber audit of the remote computers, communicate with the remote computers to determine whether each of the remote computers has ransomware protection enabled, and responsive to data indicating that at least one of the remote computers has ransomware protection disabled, generate a command for the at least one of the remote computers to update settings to enable ransomware protection such that the at least one of the remote computers enables ransomware protection.

2. The cyber coordination system of claim 1, wherein the one or more processors are further programmed to, responsive to input requesting the first type of cyber audit of the remote computers, communicate with the remote computers to determine whether each of the remote computers has a specified patch for software, and responsive to data indicating that at least one of the remote computers does not have the specified patch, generate a report indicating that the at least one of the remote computers does not have the specified patch.

3. The cyber coordination system of claim 1, wherein the one or more processors are further programmed to, responsive to input requesting the second type of cyber audit of the remote computers, communicate with the remote computers to determine whether each of the remote computers has a specified patch for software, and responsive to data indicating that at least one of the remote computers does not have the specified patch, generate a command for the at least one of the remote computers to install the specified patch such that the at least one of the remote computers installs the specified patch.

4. The cyber coordination system of claim 1, wherein the one or more processors are further programmed to, after the at least one of the remote computers enables the ransomware protection, update a score indicating a degree to which criteria of the second type of cyber audit are satisfied.

5. The cyber coordination system of claim 4, wherein at least some of the criteria are defined by regulations.

6. The cyber coordination system of claim 4, wherein at least some of the criteria are defined by conditions of an insurance policy.

7. The cyber coordination system of claim 1, wherein the one or more processors are further programmed to, responsive to the input requesting the first type or second type of cyber audit, recommend cyber training or revisions to data back-up procedures.

8. A cyber coordination system comprising:
one or more processors programmed to,
responsive to input requesting a first type of cyber audit of remote computers, communicate with the remote computers to determine whether each of the remote computers has a specified patch for software, and responsive to data indicating that at least one of the remote computers does not have the specified patch, generate a report indicating that the at least one of the remote computers does not have the specified patch, and
responsive to input requesting a second type of cyber audit of the remote computers, communicate with the remote computers to determine whether each of the remote computers has the specified patch for software, and responsive to data indicating that at least one of the remote computers does not have the specified patch, generate a command for the at least one of the remote computers to install the specified patch such that the at least one of the remote computers installs the specified patch.

9. The cyber coordination system of claim 8, wherein the one or more processors are further programmed to, responsive to input requesting the first type of cyber audit of the remote computers, communicate with the remote computers to determine whether each of the remote computers has ransomware protection enabled, and responsive to data indicating that at least one of the remote computers has ransomware protection disabled, generate a report indicating that the at least one of the remote computers has ransomware protection disabled.

10. The cyber coordination system of claim 8, wherein the one or more processors are further programmed to, responsive to input requesting the second type of cyber audit of the remote computers, communicate with the remote computers to determine whether each of the remote computers has ransomware protection enabled, and responsive to data indicating that at least one of the remote computers has ransomware protection disabled, generate a command for the at least one of the remote computers to update settings to enable ransomware protection such that the at least one of the remote computers enables ransomware protection.

11. The cyber coordination system of claim 10, wherein the one or more processors are further programmed to, after the at least one of the remote computers enables the ransomware protection, update a score indicating a degree to which criteria of the second type of cyber audit are satisfied.

12. The cyber coordination system of claim 11, wherein at least some of the criteria are defined by regulations.

13. The cyber coordination system of claim 11, wherein at least some of the criteria are defined by conditions of an insurance policy.

14. The cyber coordination system of claim 8, wherein the one or more processors are further programmed to, responsive to the input requesting the first type or second type of cyber audit, recommend cyber training or revisions to data back-up procedures.

15. A cyber coordination method comprising:
responsive to a score, derived from data that results from monitoring a plurality of endpoints, being within a desired range of values and the data indicating that one of the endpoints has ransomware protection disabled or does not have a specified patch for software, generating an alert; and
responsive to the score being outside the desired range of values, commanding the one of the endpoints to enable ransomware protection such that the one of the endpoints enables ransomware protection or to install the specified patch such that the one of the endpoints installs the specified patch.

16. The cyber coordination method of claim 15 further comprising updating the score after the commanding.
